(19) United States
(12) Patent Application Publication
(10) Pub. No.: US 2003/0173409 A1
(43) Pub. Date: Sep. 18, 2003

(54) Transport or conveyor unit for a chip, particularly a telephone chip

(76) Inventors: Werner Vogt, Remerschil (CH); Johann Locher, Werzikon (CH)

Correspondence Address: OSTROLENK FABER GERB & SOFFEN, 1180 AVENUE OF THE AMERICAS, NEW YORK, NY, 100368403

(21) Appl. No.: 10/312,941

(22) PCT Filed: Jun. 28, 2001
(86) PCT No.: PCT/IB01/01151

(30) Foreign Application Priority Data
Jun. 28, 2000 (DE) 10030 622.5
Jun. 28, 2000 (DE) 20011012.8

(51) Int. Cl. G06K 19/06

(52) U.S. Cl. 235/492

(57) ABSTRACT

A transport or conveyer unit for a chip, particularly for a (GSM) telephone chip (SIM card), is characterised by a CD card known per se in the usual credit or bank card format, which has a mounting or fixing area for the telephone chip and whose data track contains information from the chip telephone company sending the chip to the person acquiring the (telephone) chip.

The present invention relates to a transport or conveyor unit for a chip of small format, particularly a (GSM) telephone chip, as defined in the preamble of claim 1, and is intended for use in delivering such a chip, for example a telephone chip usually also described as SIM card, from the sender of the (telephone) chip, i.e. for example a telephone company, to the customer, and this safely and in a way connected with other decisive advantages.

The invention will be described hereafter in connection with a SIM card. It is, however, understood that the invention is not limited to such a telephone chip or a SIM card, but can be used also for other chips of small format.

Considering that due to the progressive miniaturization of the mobile telephones presently offered on the market, i.e. usually so-called handies, SIM cards likewise have a very small format of, maximally, twice the size of a thumb, shipment of such SIM cards is in a sense problematic as the card may get lost when placing it in the shipping envelope or when the latter is opened. However, the SIM card contains important information and data that are of decisive importance for the operation of the respective handy into which the SIM card is to be inserted or fitted later.

DE 297 09 648 U1 discloses a calling card comprising a compact disk (CD) with sender's information optically stored thereon, to which a microprocessor chip is firmly connected.

From DE 42 42 247 A1, an identity card has been known on which a microprocessor chip and an optical data storage are arranged inseparably one from the other.

The invention follows a different approach and has for its object to make available to the respective user, in addition to the SIM card, other supplementary information, data of interest, aids for the use of web sites in the digital/electronic form usual today, which are generally welcome to the user, especially for that reason and separately from the basic function of the SIM card, and which users generally like to use separately at a later time.

The invention proposes to achieve that objective by a so-called CD card which as such is occasionally found today in the market and which connects the CD card with the telephone chip to form a package combination by means of which a plurality of users can be repeatedly addressed so that in addition to the safe delivery of the telephone chip a potent marketing tool is created.

A CD card is a rectangular card, built up from a plurality of plastic layers, in the usual bank or credit card format, which is however provided at its center with a central circular opening precisely conforming to the mounting opening of a normal CD disk. One side of such a CD card, which may also be completely transparent, carries a data track that can be read by a CD reader or, if desired, by a DVD reader, although this has not been implemented to this day; the circular spiral shape of that track is, however, limited by the lengthwise edges of the CD card.

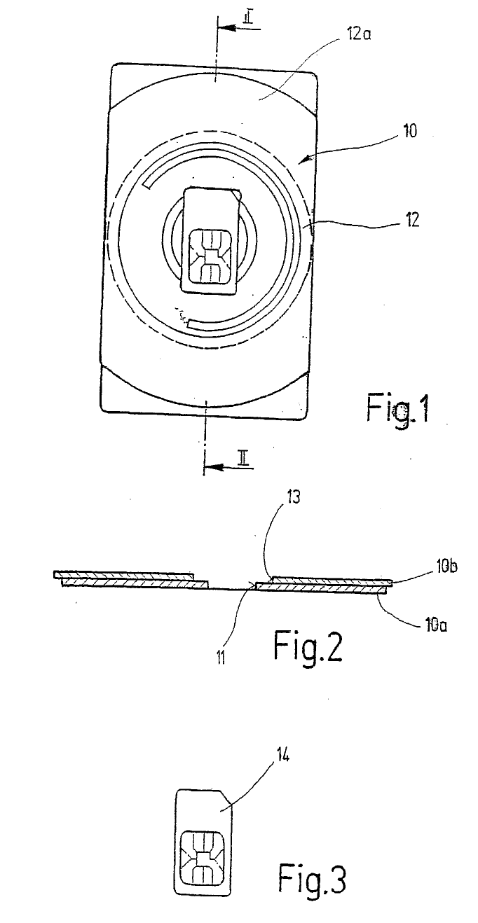

Still, there remains enough space within the ring (compare also the area enclosed by the dash-dotted ring line in FIG. 1) to accommodate a considerable quantity of information or data which, generally, may well be in the order of between 50 and 100 megabytes.

It is then possible to accommodate on that annular CD data track on the CD card certain suitable information, messages and data intended for the user of the telephone chip, which, apart from commercial pods, may also comprise effective aids, for example for the direct dialing of web sites, operating instructions for the mobile telephone, music or, generally, any other information one can think of.

As the discussion here is about the utilization of electronic media and as, further, almost any user of a mobile telephone owns a CD player as well, not seldom in the form of a laptop containing a CD/DVD drive, it will be a pleasure, which should not be underestimated, for almost any receiver of such a telephone card/CD card package combination to take note in this way of the respective information, data, web aids, operating instructions, music, including advertising.

The object underlying the present invention is achieved by the characterizing features defined in claim 1 which provide the advantage that initially, i.e. during transport and reception of the package combination, a firm connection exists between the CD card on the one hand and the telephone chip on the other hand, which is then definitely separated by the user when he removes the chip. The telephone chip is then used as usual, by inserting it into a mobile telephone, while the CD card remains available for use, including repeated use, by the receiver of the shipment, the data track being sealed in a suitable way in order to prevent damage to the track even under conditions of repeated use and rough treatment.

The CD card can be played back on any desired CD or DVD drive, especially on drives of the type usually found in laptops where a central drive shaft is provided with snap-in projections or detents by which the CD or, in the present case, the CD card is safely received and retained for being driven.

It is understood that apart from general instructions relating to the transmitted telephone chip the data track of the CD card may additionally accommodate other frequently used electronic aids, for example new drivers—so-called browsers—that help to find Internet sites quickly, or everything else a telephone company selling the chip would wish to communicate or make available to the user.

The connection between the telephone chip, i.e. the so-called SIM card, and the CD card may be effected by a cutout in the CD card, whose contours follow those of the SIM card and are so tightly sized that the SIM card can be snapped or clicked into that cutout; where sufficient space is available or where the telephone chip is small enough, that cutout can be arranged also in a marginal area of the CD card, although it is also possible, as will be described in more detail in connection with the examples that follow, to arrange the telephone chip in a corresponding cutout provided centrally in the CD card. The cutout then further and simultaneously forms the circular receiving opening for the driving arbor of a CD/DVD drive.

Since it has been usual heretofore to produce a so-called SIM card or, generally, a (GSM) telephone chip from a larger card format, by arranging the telephone chip within the limits of that larger card format, i.e. the credit card format, and punching it out thereafter, one embodiment of the present invention provides that the telephone chip can be formed integrally with the CD card on the latter's edge in one production step and can be broken away by the user later, when the SIM card/CD card package combination is received by him.

Finally, it is also possible to fix the SIM card on the CD card using a double-sided adhesive film, or to form projections or knobs on the CD card on which the periphery of the CD card is then secured by clicking it in.

According to a particularly advantageous embodiment it is provided that the telephone chip is fixed detachably on a carrier element which in turn is fixed detachably in the passage opening for the drive arbor.

That embodiment offers the particular advantage that CD cards of the kind known per se can be used and that no changes whatsoever have to be applied in order to adapt them to the telephone chip. The telephone chip can be easily removed from the CD card, together with the carrier element, and the CD card is then immediately ready for use.

Preferably, the carrier element can be fixed in the passage opening by means of a snap-in connection.

The telephone chip as such can be fixed on the carrier element by means of knobs or other projections, which are fixed on the carrier element and which correspond to the contour of the telephone chip or the SIM card.

Further embodiments and improvements of the invention are the subject-matter of the sub-claims and/or can be derived from the description that follows.

Some embodiments of the invention will be described hereafter in more detail by reference to the drawings in which:

FIG. 1 shows a diagrammatic top view of one possible embodiment of a combined transport or conveyor unit, consisting of a CD card and a telephone chip received in the latter;

FIG. 2 shows a section taken along line II-II of FIG. 1 with the telephone chip removed;

FIG. 3 shows the telephone chip or the SIM card as used today and with the usual dimensions, all representations showing the natural dimensional relationships; and

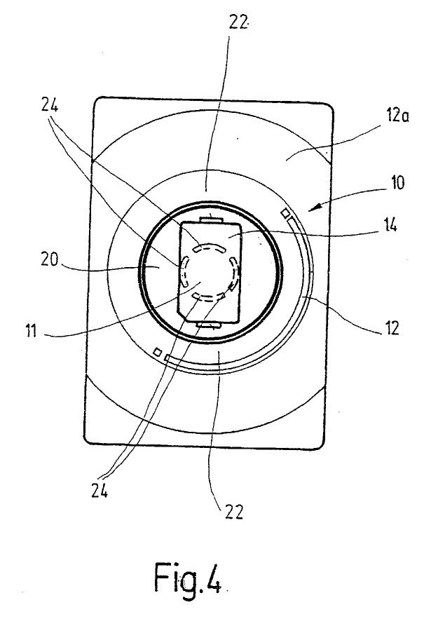

FIG. 4 shows another embodiment of a combined transport or conveyor unit consisting of a CD card and a telephone chip.

It is the basic idea of the present invention that when shipping a chip, especially a telephone chip, i.e. usually a SIM card, one should be in a position to simultaneously communicate to the user of the telephone chip, by electronic means i.e. by means of a so-called CD card, additional information, data, aids and the like by means of a so-called CD card which, considering the enormously high packing density possible today, may accommodate on its data track a plurality of information, including in particular visual information that can be read by any CD/DVD drive. It is understood in this connection that the so-called CD card may of course offer higher packing densities than the CD cards usual today and may, for example, also contain information in the DVD format.

The representation of FIG. 1 shows a CD card 10 known per se, with the usual dimensions of a credit or bank card. Such a CD card is provided with a central passage opening 11, which in the present case serves for mounting (and fixing) the CD card in a CD/DVD drive so that the data track 12 present on the CD card can be read out by the reader of the drive. With this form of CD card, the useful information is contained only inside the annular zone which coaxially encloses the central passage opening 11 and which is separated from the remaining CD card by the broken line, although it is also imaginable to have such information extend beyond that area into the remaining surface 12a of the CD card if corresponding hardware or software means are provided that account for the interruption of the data stream by the rectangular shape of the card during play-back.

In the illustrated embodiments the CD card is composed of two layers 10a, 10b, the upper layer in FIG. 2 comprising a central passage opening 11, which is insofar symmetrical to the mounting opening 13 and which may be implemented in that layer for example by punching or by any other method of removing material.

The dimensions of the mounting opening 13 closely follow the outer dimensions of a usual telephone chip, i.e. of a SIM card 14 shown in FIG. 3, so that the latter can be snapped or clicked into the recessed mounting opening 13. Thus, the two components, namely the CD card and the telephone card, form a single package combination which is ready for shipment. As has been mentioned before, the data track 12 of the CD card may store any desired information of interest, messages, operating instructions, aids for establishing direct connection with web sites, music or the like, including drivers or other update files or small games. All this is possible because the data quantity such a track can accommodate is between 50 and 100 megabytes, and may even be considerably increased by the introduction of higher-packing storage media.

When the package combination is received by the user, he snaps the telephone card 14 out of its holder, formed by the mounting opening 13, and the two parts can then be used separately for their respective purposes.

Another, especially advantageous embodiment of a combined transport or conveyor unit consisting of a CD card and a telephone chip is shown in FIG. 4.

In the embodiment illustrated in FIG. 4 elements which are identical to the elements of the first embodiment illustrated in FIG. 1 are indicated by the same reference numerals so that all that has been said with respect to them in the discussion of the first embodiment is included herein for the purposes of the description that follows.

Contrary to the first embodiment illustrated in FIG. 1, the telephone chip 14 is fixed in this case on a carrier 20 by means of projections 22 on which the telephone chip can be detachably secured by snapping it in. The carrier element 20 as such may have a circular shape, as shown for example in FIG. 4, or any other shape. On its side facing away from the telephone chip 14, the carrier element is equipped with detents 24 that are adapted to the passage opening 11 of the CD card in such a way that the entire mounting element 40 can be detachably engaged in the passage opening 11. The shape of the detents may, for example, be identical to that of the detents provided in a CD case for holding a CD ROM. The mounting element 20 can easily be removed from the CD card. A special advantage is seen in the fact that no changes whatsoever need to be applied to the CD card and that especially no additional receiving elements, mounting elements or the like have to be provided on the card for mounting or fixing the telephone chip.

The advantages of such a combination are evident, also with respect to the shipping expense, it being now no longer necessary to enclose a printed, in some cases even voluminous owner's manual which, being incompatible with modern usage, is anyway often not read by the users as reading a manual is directly opposed to the apparent pleasure a user experiences when taking note of the information of a CD card accompanied by sound and pictures.

It is understood that the connection between the CD card on the one hand and the telephone chip on the other hand can be realized in any desired way provided always that the CD card comprises a suitable area for mounting or fixing the telephone card. That area can be provided, for example, by producing the telephone chip in one operation together with the CD card, as a component of the CD card contained inside its usual outer dimensions, or as an enlargement of the CD card so that no separate production step will be required; the user then only has to remove the SIM card from the CD card, for example by breaking it off along perforated lines or cuts. However, instead of providing a clearly visible mounting opening 13 on the CD card, there is also the possibility to merely provide a few projecting knobs or projections that tightly engage and hold the SIM card, when the latter is fitted, until it is removed by the user, or else to fix the SIM card on a corresponding free area of the CD board by means of a double-sided adhesive film. The user then pulls the telephone card off the CD card and, conveniently, also removes the adhesive film for later use of the CD card.

It is further understood that the telephone chip or the SIM card may be configured as a so-called “prepaid card” with our without contacts, which means that a predefined amount of money—and initially only that amount—is available for calls, which amount can then at any time be renewed or changed by “downloading”. That “downloading” is then effected by means of programs stored on the CD card or on another attached data carrier whereby “integration of a telephone chip with a data carrier for “prepaid downloading” is achieved.

The outer shape of the data carrier, for example in the form of the described CD card or, if desired, in the form or a heart or a cloverleaf, maybe even in the form of a minidisk, is basically freely selectable and insofar not limited to the format of a CD card.

1. Transport or conveyor unit for a chip (14), the unit comprising a data carrier (10), which has a mounting or fixing area for the chip (14) and whose data track (12) contains information from the company sending the chip (14) to the person acquiring the chip, characterized in that the data carrier (10) comprises a mounting opening (13), serving as holding means, in which the chip (14) is snapped-in in flush arrangement, and that the mounting opening (13) is arranged centrally in the middle of the data carrier (10) and forms insofar, together with a passage opening (11) in the data carrier (10), a common opening for a drive arbor.

2. The transport or conveyor unit as defined in claim 1, characterized in that the chip (14), especially a SIM card constituting the telephone chip, is arranged in physical holding connection with the data carrier (10).

3. Transport or conveyor unit for a chip (14), the unit comprising a data carrier (10), which has a mounting or fixing area for the chip (14) and whose data track (12) contains information from the company sending the chip (14) to the person acquiring the chip, characterized in that the data carrier (10) comprises knobs or other projections that follow the outer contour of the chip (14) and thereby tightly hold the chip (14).

4. The transport or conveyor unit as defined in claim 3, characterized in that the chip (14), especially a SIM card constituting the telephone chip, is arranged in physical holding connection with the data carrier (10).

5. Transport or conveyor unit for a chip (14), the unit comprising a data carrier (10), which has a mounting or fixing area for the chip (14) and whose data track (12) contains information from the company sending the chip (14) to the person acquiring the chip, characterized in that the chip (14) is fixed on the data carrier (10) by means of a double-sided adhesive film.

6. Transport or conveyor unit for a chip (14), the unit comprising a data carrier (10), which has a mounting or fixing area for the chip (14) and whose data track (12) contains information from the company sending the chip (14) to the person acquiring the chip, characterized in that the chip (14) is part of the data carrier blank and that the configuration is such that the chip can be broken away.

7. Transport or conveyor unit for a chip (14), the unit comprising a data carrier (10), which has a mounting or fixing area for the chip (14) and whose data track (12) contains information from the company sending the chip (14) to the person acquiring the chip, characterized in that the chip (14) is detachably fixed on a carrier element (20) of the unit which is detachably mounted in the passage opening (11) for the drive arbor provided in the data carrier (10).

8. The transport or conveyor unit as defined in claim 7, characterized in that the carrier element (20) can be fixed in the passage opening (11) by means of a snap-in connection.

9. The transport or conveyor unit as defined in claim 7 or claim 8, characterized in that the carrier element (20) comprises knobs or other projections that follow the outer contour of the chip (14) and thereby tightly hold the chip (14).

10. The transport or conveyor unit as defined in any of claims 1 to 9, characterized in that the chip (14) contains a predetermined amount of money for telephone calls and can be re-charged at any time for further use by downloading additional amounts using data carrier information.
